(19) United States
(12) Patent Application Publication
(10) Pub. No.: US 2020/0236872 A1
(43) Pub. Date: Jul. 30, 2020

(54) Kit and Method for Grass-Like Edging

(71) Applicant: John Edward Aiken, Monroevile, PA (US)

(72) Inventor: John Edward Aiken, Monroevile, PA (US)

(21) Appl. No.: 16/776,240

(22) Filed: Jan. 29, 2020

Related U.S. Application Data
(60) Provisional application No. 62/798,115, filed on Jan. 29, 2019.

(51) Int. Cl. A01G 13/02; E04H 17/06

(52) U.S. Cl. CPC A01G 13/0268; E04H 17/063; A01G 13/0293

(57) ABSTRACT

A kit for installing a horizontal grass-like weed-blocking border for ground area adjacent vertical outdoor structures includes at least two elongated synthetic turf strips with a width in a predetermined range, at least two hold-down pieces, and instructions for use.

### CROSS REFERENCE TO RELATED APPLICATION

This patent application is related to and claims priority from U.S. Provisional Patent Application Ser. No. 62/798,115 filed Jan. 29, 2019.

### FIELD OF THE INVENTION

The present invention relates, in general, to weed-block edging for lawns abutting walls or fences, and, more particularly, this invention relates to an weed/grass-blocking edging with improved appearance and low maintenance.

### BACKGROUND ART

Prior to the conception and development of the present invention, lawn care involving retaining walls, fences, and the like required bothersome trimming of grass and weeds up against the wall or fence. Also, between trimmings, the grass or weed growth in front of the wall exhibits an unkempt appearance. This is due to the fact that lawn mower blades cannot get right up against the wall.

Conway disclosed in U.S. Pat. No. 6,038,811 an L-shaped lawn edging system with a plain smooth horizontal surface.

Also, Fritch in U.S. Pat. No. 5,157,867 teaches a flexible landscape edging consisting of a mowing strip, an anchoring strip, and a retainer portion. It would not look natural in a grass turf area.

Numerous others have proposed solutions to the problem, but without much regard to blending into the adjacent grass area. There is obviously a long-standing need for a durable, natural-looking edging that blocks vegetation and can tolerate herbicides.

### SUMMARY OF THE INVENTION

The present invention overcomes shortcomings of the prior art by providing a simple, durable, and more esthetically pleasing alternative to trimming unwanted grass and weeds adjacent wall, fences, and buildings. Two or more elongated synthetic turf strips of predetermined width are packaged as a kit which also includes installation instructions and hold-down pins.

### OBJECTS OF THE INVENTION

It is, therefore, one of the primary objects of the present invention to provide a grass-like and durable edging for outdoor vertical surfaces for the purpose of suppressing vegetation adjacent the vertical surface.

Another object of the present invention is to provide an easy-to-store kit including multiple elongated synthetic turf strips, anchoring pins, and installation instructions

Still another object of the present invention is to provide a simple, durable alternative to trimming unwanted grass and weeds adjacent walls, fences, and buildings while blending in with adjacent grass.

Yet another object of the present invention is to provide a weed-blocking strip that looks much like real grass, but is not harmed by herbicides.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures.

### BRIEF DESCRIPTION OF THE DRAWINGS

FIG. 1 provides a plan view of an exemplary kit embodiment of the present invention.

FIG. 2 is a perspective view of the preferred means for packaging and shipping the kit of the present invention.

FIG. 3 is a perspective view of the present invention shown in use.

FIG. 4 provides an additional perspective view of use of the present invention.

FIG. 5 is an exemplary flowchart of a method for deploying the kit of the invention.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, very similar components which have identical functions have been identified with identical reference numerals throughout the several views illustrated in the drawing figures.

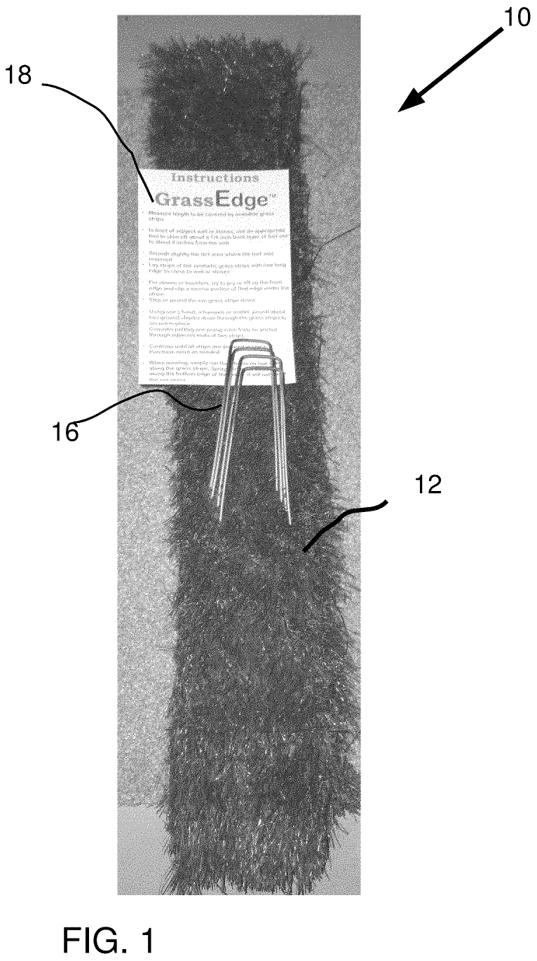

Referring initially to FIG. 1, a plan view of an exemplary kit embodiment of the present invention is provided as indicated by 10. The kit contains at least two elongated high-quality synthetic grass strips 12, preferably five. By “high-quality” is meant that the grass filaments are at least 1-inch (2.5 cm) high. For purposes herein, “elongated” is taken to mean a length to width ratio of at least 8. For each grass-like strip, there are two hold-down pins or staples 16. Other types of hold-down devices, such as pegs, would serve as well. Also, there is a written instruction sheet 18 for a typical installation of the kit parts. As an alternative, the written instructions could be merely a link to a website providing the latest instructions. In commercial practice, the kit parts would all be enclosed in an elongated clear plastic film sleeve heat sealed at each end.

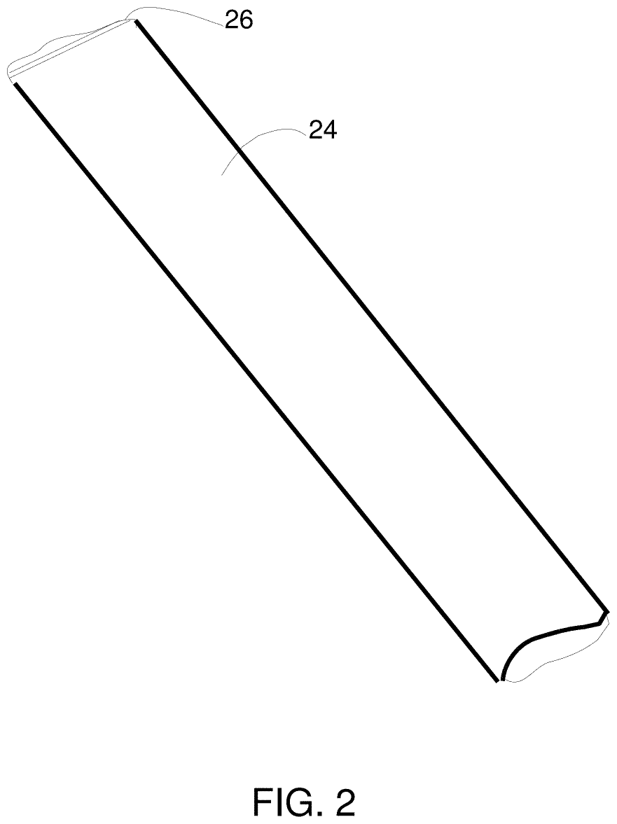

FIG. 2 is a perspective view of the preferred means for packaging and shipping the kit of the present invention. A substantially clear elongated sleeve 24 slightly longer and wider that the grass strips, preferably of thick PVC film, is heat sealed at one end, 26, then after being loaded with the kit parts, is heat sealed at the end opposite 26.

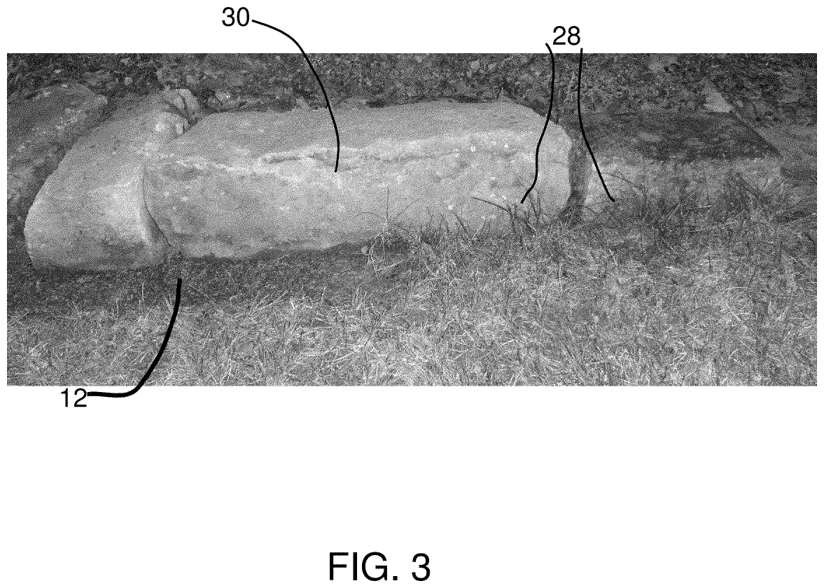

FIG. 3 is a perspective view of the present invention shown in use along a portion of a boulder wall 30. On the right-side portion, where the present invention is not positioned, unsightly grass 28 is growing up and needs to be trimmed periodically. The grass-like edging 12 has a portion of the side adjacent the boulders pinched underneath to help hold it in place. Although not seen, hold-down pins also assist in keeping the synthetic turf in place. The synthetic turf 12 is resistant to herbicides, thus any weeds or grass that do come up adjacent the boulder can be sprayed without harming the natural grass nearby. The one-inch minimum pile height makes it look somewhat natural and blend well with surrounding natural grass.

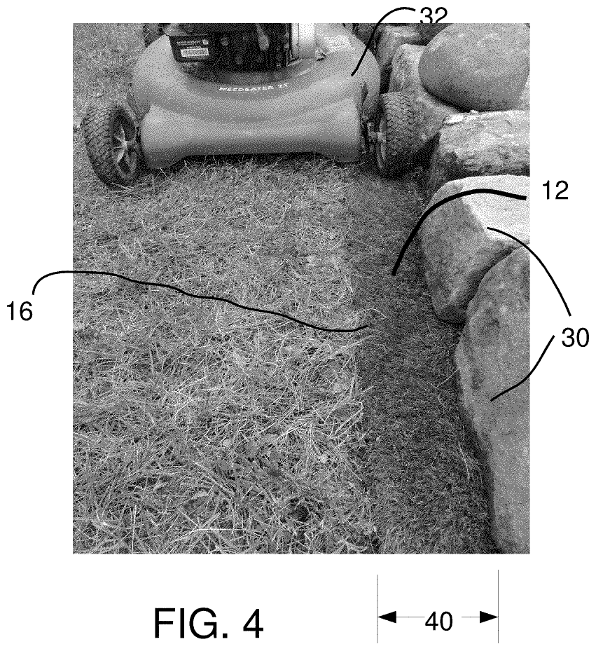

FIG. 4 provides an additional perspective view of use of the present invention when a lawnmower 32 is in use. The width 40 of the synthetic-grass strips 12 is such that one edge of the strip can be tucked under the boulders and there is no part of the natural grass that the mower 32 does not reach. That width is generally in the range of 3 to 5 inches, and the strip length is 36 inches or more. The length can be longer, but the 48-inches is favorable for curved retaining walls, and also for packaging. Although not readily visible, landscaping hold-down pins or staples 16 help keep the strips in place and prevent them from getting caught in the mower.

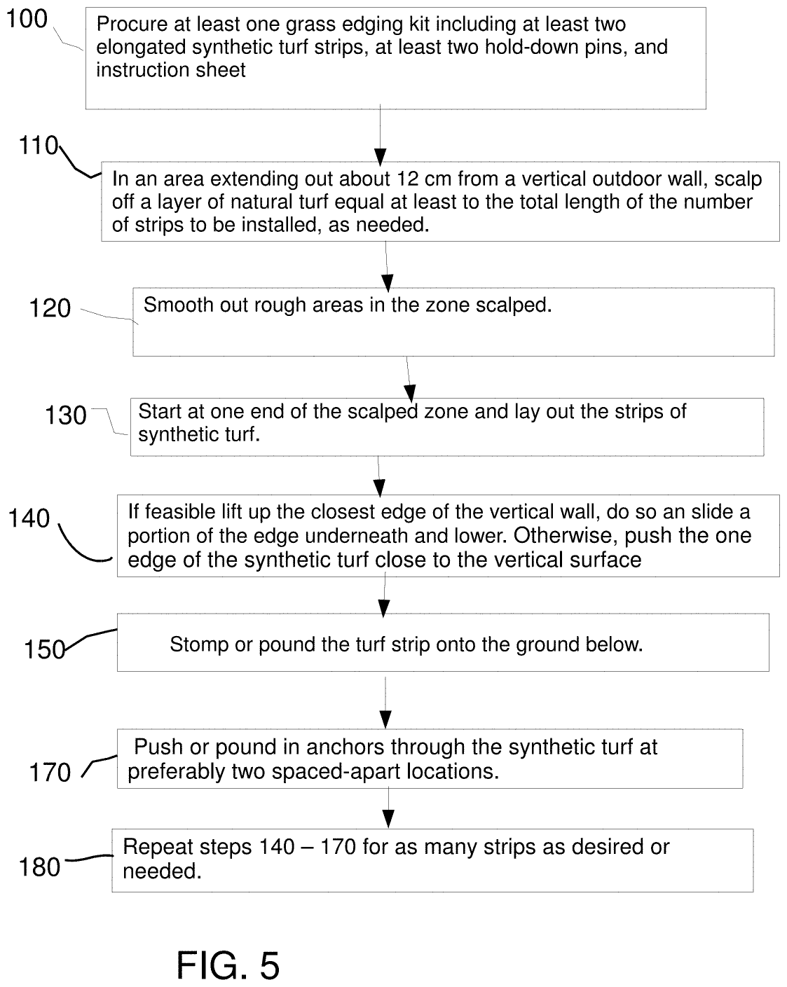

FIG. 5 is an exemplary flowchart of a method for deploying the kit of the invention, which starts with procuring the aforementioned kit. If natural turf is present near the vertical surface being targeted, a thin layer should be scraped (scalped) off such that the installed synthetic turf will be essentially flush. After smoothing slightly, the strips can be laid down end to end, and pinned down to the ground underneath with the provided hold-down pins.

While a preferred version of the present invention has been described in sufficient detail above to enable a person skilled in the relevant art to make and use the same, it should be obvious that various other adaptations and modifications can be envisioned by those persons skilled in such art without departing from the spirit of the invention.

I claim:

1. An edging kit for blocking vegetation growth on ground adjacent vertical structures comprising:
a) at least two elongated synthetic grass strips of a first predetermined length and a first predetermined width having green filaments on one side of a minimum predetermined height,
b) at least two hold-down pins, and
c) instructions for use.

2. The edging kit of claim 1 wherein said at least two elongated synthetic grass strips number five.

3. The edging kit of claim 1 wherein said first predetermined length is between three and six feet.

4. The edging kit of claim 1 wherein said first predetermined width is between 3 and 5 inches.

5. The edging kit of claim 1 wherein said minimum predetermined height is 1.0 inch.

6. The edging kit of claim 1 wherein the kit is enclosed in an elongated clear plastic film sleeve heat sealed at each end.

7. A method for installing a synthetic turf vegetation-blocking edging which starts with procuring a kit including at least two elongated synthetic grass strips of a first predetermined length and a first predetermined width having green filaments on one side of a minimum predetermined height, at least two hold-down pins, and instructions for use. If natural turf is present near the vertical structure being targeted, a thin layer is scraped (scalped) off such that the installed synthetic turf will be essentially flush with adjacent turf. After smoothing slightly, the strips are laid down end to end, tamped down, and then pinned down to the ground underneath with the provided hold-down pins.

8. The method of claim 7 wherein said vertical structure is one of a wall, boulder row, and fence.
